(19) United States
(12) Patent Application Publication
(10) Pub. No.: US 2012/0106466 A1
(43) Pub. Date: May 3, 2012

(54) SYSTEM AND METHOD TO AVOID DOWNLINK CONTROL CHANNEL COVERAGE LIMITATION IN A COMMUNICATION SYSTEM

(75) Inventors: Markku Tapani Kuusela, Lahti (FI); Jari Petteri Lunden, Espoo (FI)

(73) Assignee: NOKIA CORPORATION, Espoo (FI)

(21) Appl. No.: 13/139,995

(22) PCT Filed: Dec. 14, 2009
(86) PCT No.: PCT/FI2009/050997

§ 371 Date: Jul. 27, 2011

Related U.S. Application Data
(60) Provisional application No. 61/122,988, filed on Dec. 16, 2008.

(51) Int. Cl. H04W 72/04

(52) U.S. Cl. 370/329

(57) ABSTRACT

A method, apparatus, and system for providing a communication resource for a communication device in a communication system. In one embodiment, an apparatus includes a processor (410) and memory (450) having computer program code. The memory (450) and the computer program code is configured to, with the processor (400), cause the apparatus to perform at least the following: assess a capacity of a physical downlink control channel, provide a pre-assigned communication resource for transmission of data to a communication device upon determining insufficient capacity is available in the physical downlink control channel, and format the data for transmission to the communication device employing the pre-assigned communication resource.

This application claims the benefit of U.S. Provisional Application No. 61/122,988 entitled “System and Method to Avoid Downlink Control Channel Coverage Limitation in a Communication System,” filed on Dec. 16, 2008, which is incorporated herein by reference.

### TECHNICAL FIELD

The present invention is directed, in general, to communication systems and, in particular, to a system, apparatus and method for providing a communication resource for a communication device in a communication system.

### BACKGROUND

Long term evolution (“LTE”) of the third generation partnership project (“3GPP”), also referred to as 3GPP LTE, refers to research and development involving the 3GPP Release 8 and beyond, which is the name generally used to describe an ongoing effort across the industry aimed at identifying technologies and capabilities that can improve systems such as the universal mobile telecommunication system (“UMTS”). The goals of this broadly based project include improving communication efficiency, lowering costs, improving services, making use of new spectrum opportunities, and achieving better integration with other open standards. The 3GPP LTE project is not itself a standard-generating effort, but will result in new recommendations for standards for the UMTS.

The evolved universal terrestrial radio access network (“E-UTRAN”) in 3GPP includes base stations providing user plane (including packet data convergence protocol/radio link control/medium access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as user equipment (“UE”). A base station is an entity of a communication network often referred to as a Node B or an NB. Particularly in the E-UTRAN, an “evolved” base station is referred to as an eNodeB. For details about the overall architecture of the E-UTRAN, see 3GPP Technical Specification (“TS”) 36.300 v1.0.0 (2007 March), which is incorporated herein by reference.

As wireless communication systems such as cellular telephone, satellite, and microwave communication systems become widely deployed and continue to attract a growing number of users, there is a pressing need to accommodate a large and variable number of communication devices transmitting a growing range of communication applications with fixed resources. Traditional communication system designs employing a fixed communication resource have become challenged to accommodate the rapidly growing customer base and the expanding levels of service.

One area that has challenged the distribution of a communication resource is the allocation of control channel information on a downlink control channel for voice over Internet protocol (“VoIP”) traffic. In the downlink (“DL”) channel of LTE, the data channel (the physical downlink shared channel, or “PDSCH”) is shared among many user equipment. Control information for the data channel is needed in every transmit time interval (“TTI”) to identify the scheduled user equipment as well as the physical resource blocks (“PRBs”) and the modulation and coding scheme (“MCS”) for each scheduled user equipment. The physical channel that carries this control information in a downlink is called the physical downlink control channel (“PDCCH”). The packet scheduling (“PS”) that determines where each data packet is transmitted with the associated PDCCH signaling is referred to as “fully dynamic PS,” as described in 3GPP document R2-070006, entitled “Scheduling of LTE DL VoIP,” Nokia, 3GPP TSG-RAN WG2 #56bis, Jan. 15-19, 2007, which is incorporated herein by reference. In the 3GPP, it has been agreed that the baseline packet scheduling method for VoIP downlink traffic is fully dynamic. It is known that the performance of fully dynamic packet scheduling suffers from control channel limitations, because each transmission is signaled by layer1/layer 2 (“L1/L2”) control signaling, which consumes a substantial level of bandwidth that may exceed the bandwidth available in the PDCCH.

In order to avoid control channel limitations for VoIP traffic or otherwise in LTE, a concept of semi-persistent packet scheduling was adopted in 3GPP for LTE. Semi-persistent packet scheduling can be viewed as a combination of dynamic and persistent scheduling methods, as described in 3GPP document R2-070475, entitled “Downlink Scheduling for VoIP,” Nokia, RAN2#57, February 2007, (“R2-070475”), which is incorporated herein by reference. In this combined scheduling arrangement, initial transmissions of VoIP traffic are scheduled without assigned L1/L2 control signaling by using persistently allocated time and frequency resources. Nonetheless, possible hybrid automatic retransmit request (“HARQ”) re-transmissions and silence insertion descriptor (“SID”) transmissions are scheduled dynamically. The semi-persistent communication resource allocation method adopted in 3GPP LTE is abbreviated as talk spurt-based persistent allocation, also referred to as semi-persistent scheduling (“SPS”), as described in R2-070475 and in 3GPP document R2-074678, entitled “Stage 3 Aspects of Persistent Scheduling,” Nokia/Nokia Siemens Networks, RAN2#60, November 2007, which is incorporated herein by reference. At the beginning of a talk spurt, in the downlink direction, a persistent communication resource allocation is made for the user, and this dedicated time and frequency resource is used for initial transmissions of VoIP data packets. At the end of the talk spurt, the persistent communication resource allocation is released. Thus, the released communication resource can be allocated to another VoIP user equipment, which enables efficient usage of PDSCH bandwidth.

Since scheduling of VoIP downlink traffic is done either by using the baseline packet scheduling (which is a fully dynamic packet scheduling process) or by the alternative semi-persistent packet scheduling method, both of which rely on PDCCH signaling with its limited bandwidth, the ability to provide sufficient communication resources for PDCCH coverage remains an unresolved issue that will limit the coverage and performance of VoIP downlink traffic or otherwise. The PDCCH coverage particularly begins to limit VoIP downlink performance at low PDCCH bandwidths (e.g., at 1.4 megahertz (“MHz”) bandwidth), wherein PDCCH transmission resources are very limited.

Thus, in view of the growing deployment of communication systems such as cellular communication systems, further improvements for VoIP downlink packet scheduling systems are necessary to mitigate the negative impact of PDCCH coverage/bandwidth limitations on downlink traffic such as VoIP data packets. Therefore, what is needed in the art is a system and method that avoids the deficiencies of communication systems employing conventional downlink communication resource allocation procedures.

### SUMMARY OF THE INVENTION

These and other problems are generally solved or circumvented, and technical advantages are generally achieved, by embodiments of the present invention, which include a method, apparatus, and system for providing a communication resource for a communication device in a communication system. In one embodiment, an apparatus includes a processor and memory having computer program code. The memory and the computer program code is configured to, with the processor, cause the apparatus to perform at least the following: assess a capacity of a physical downlink control channel, provide a pre-assigned communication resource for transmission of data to a communication device upon determining insufficient capacity is available in the physical downlink control channel, and format the data for transmission to the communication device employing the pre-assigned communication resource.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an exemplary environment for application of embodiments of the invention;

FIG. 3 illustrates a diagram of an exemplary frame structure for a downlink frame in accordance with embodiments of the invention;

FIG. 4 illustrates a block diagram of an embodiment of a communication element of a wireless communication system that provides an environment for application of embodiments of the invention; and

FIG. 5 illustrates a flow diagram of an embodiment of a method of operating a communication system in accordance with embodiments of the invention.

### DETAILED DESCRIPTION OF ILLUSTRATIVE EMBODIMENTS

The making and using of the present embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of a system and method for allocating communication resources in a downlink to a communication device such as user equipment communicating traffic such as VoIP data packets.

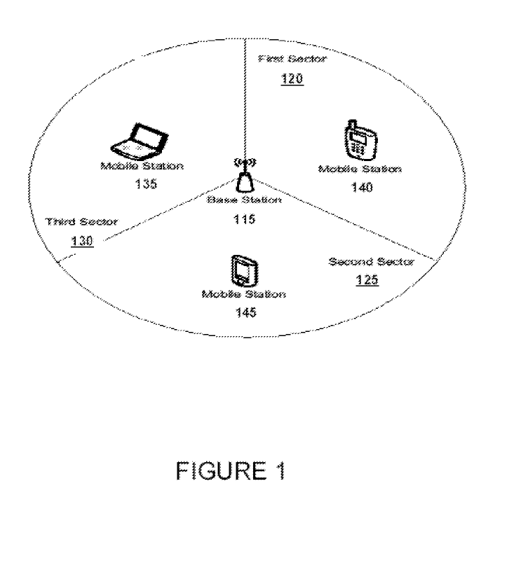

Turning now to FIG. 1, illustrated is a system level diagram of an embodiment of a communication system including a base station 115 and wireless communication devices (e.g., user equipment) 135, 140, 145 that provides an exemplary environment for application of embodiments of the invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. The sectors are formed by focusing and phasing the radiated and received signals from the base station antennas. The plurality of sectors increases the number of subscriber stations (e.g., the wireless communication devices 135, 140, 145) that can simultaneously communicate with the base station 115 without the need to increase the utilized bandwidth by reduction of interference that results from focusing and phasing base station antennas. The radiated and received frequencies utilized by the communication system illustrated in FIG. 1 would typically be two gigahertz to provide non-line-of-sight communication.

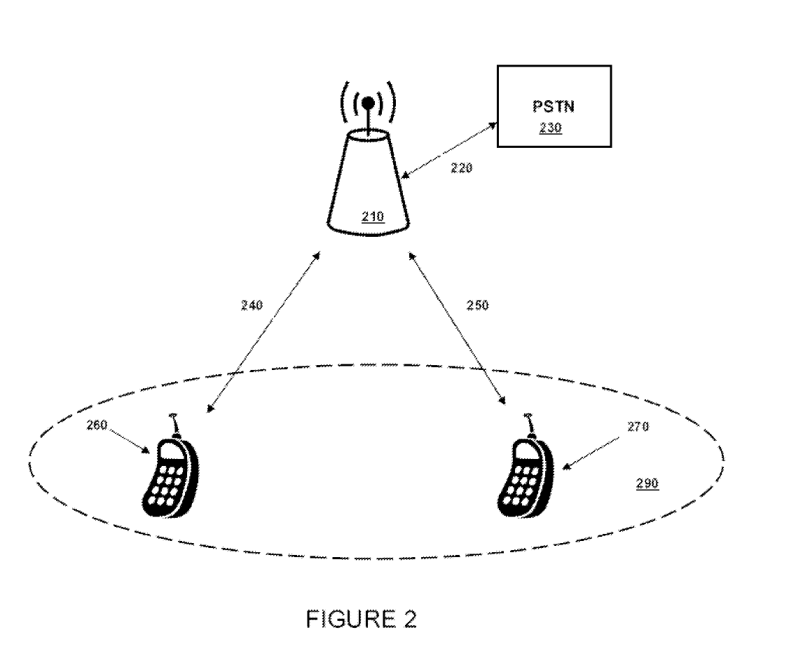

Turning now to FIG. 2, illustrated is a system level diagram of an embodiment of a communication system including wireless communication devices that provides an exemplary environment for application of embodiments of the invention. The communication system includes a base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to wireless communication devices 260, 270, respectively that lie within its cellular area 290.

In operation of the communication system illustrated in FIG. 2, the base station 210 communicates with each wireless communication device 260, 270 through control and data communication resources allocated by the base station 210 over the communication paths 240, 250, respectively. The control and data communication resources may include frequency and time-slot communication resources in frequency division duplex (“FDD”) and/or time division duplex (“TDD”) communication modes.

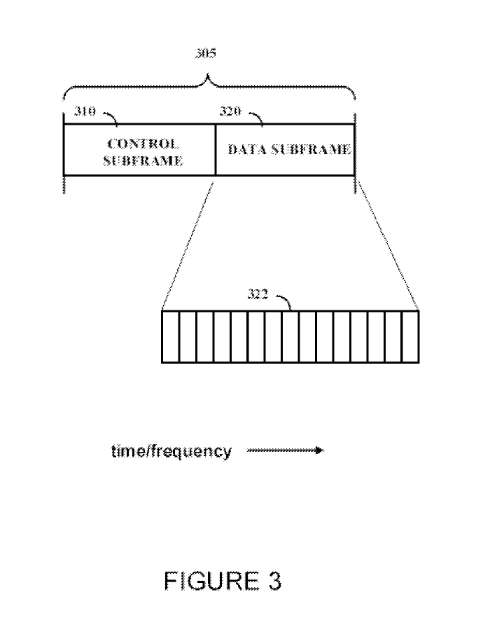

Turning now to FIG. 3, illustrated is a diagram of an exemplary frame structure for a downlink frame 305 in accordance with embodiments of the invention. The downlink frame 305 may be employed with a frequency division or time division duplex wireless communication system, or a combined frequency division/time division communication system. The downlink frame 305 includes a control subframe (e.g., a PDCCH 310) and a data subframe (e.g., a PDSCH 320). The PDCCH 310 provides control signaling including transport format and resource allocation related to the downlink shared channel (“DL-SCH”) and the paging channel (“PCH”), and HARQ information related to the DL-SCH. The PDCCH 310 also provides control signaling including transport format and resource allocation related to the uplink shared channel (“UL-SCH”), and HARQ information related to the UL-SCH. Additionally, an acknowledgement/non-acknowledgement (“ACK/NACK”) response for the uplink is typically transmitted on a physical HARQ indicator channel (“PHICH”) and for the downlink on a physical uplink control channel (“PUCCH”). The PDSCH 320 includes a plurality of time and/or frequency slots such as slot 322 that may be utilized by a communication element such as a communication device (e.g., user equipment) to transmit payload data packets. A slot 322 is a basic unit for bandwidth allocation. Of course, the downlink frame 305 may include other subframes or channels in accordance with the design of a particular communication system.

In general, the PDCCH is transmitted during the first “N” symbols of an orthogonal frequency division multiplex (“OFDM”) subframe. As indicated in 3GPP specifications, the possible values for N range from one to three symbols per OFDM subframe. A PDCCH carries at least the following control information for scheduled users in the downlink direction, namely, a dynamic time and/or frequency allocation and the MCS to be used in the data transmission. If the scheduled user equipment fails to receive the control information in the PDCCH correctly, the associated data is lost. Moreover, the PDCCH also carries the uplink traffic-related signaling, since scheduling grants for the physical uplink shared channel (“PUSCH”) scheduling are also transmitted on the PDCCH.

The minimum communication resource allocation in a single PDCCH is a control channel element (“CCE”), which includes the number of resource elements (“REs”). An resource element is a subcarrier symbol within an OFDM symbol. The exact number of resource elements in a control channel element depends, inter alia, on the used channel bandwidth (e.g., for 1.4 MHz bandwidth it is about 28 subcarrier symbols, whereas for five MHz bandwidth it is about 36 subcarrier symbols). In order to increase PDCCH coverage, aggregation of multiple control channel elements is allowed to provide signaling redundancy for user equipment operating in poor channel conditions. Possible values for the number of control channel elements per scheduled user equipment are one, two, four or eight control channel elements. The number of allocated control channel elements per scheduled user equipment is derived from a wideband channel quality information (“CQI”) reported by user equipment to a serving base station. One mechanism to improve PDCCH coverage is control of the transmitted power level for the allocated control channel elements. By doing so, part of the transmission power of the control channel elements allocated to user equipment operating under favorable channel conditions can be allocated to user equipment operating under poor channel conditions, which can lead to coverage improvement associated with the PDCCH.

Since the total number of resource elements reserved for PDCCH transmission is given by the product N*Ns, where Ns is the total number of subcarriers used for data transmission in the downlink direction, the total transmission capacity of a PDCCH is directly proportional to the used PDSCH bandwidth. This means that at very low PDCCH bandwidths, the total available PDCCH communication resources might be limited that a full aggregation of eight control channel elements is not possible, which indicates that the user equipment operating at the edges of a cell (e.g., wherein each user equipment may employ eight control channel elements) may fall outside network coverage due to limitation of PDCCH communication resources. For example, at 1.4 MHz bandwidth, the total amount of control channel elements allocated to downlink/uplink scheduling-related signaling may, in practice, be limited to four.

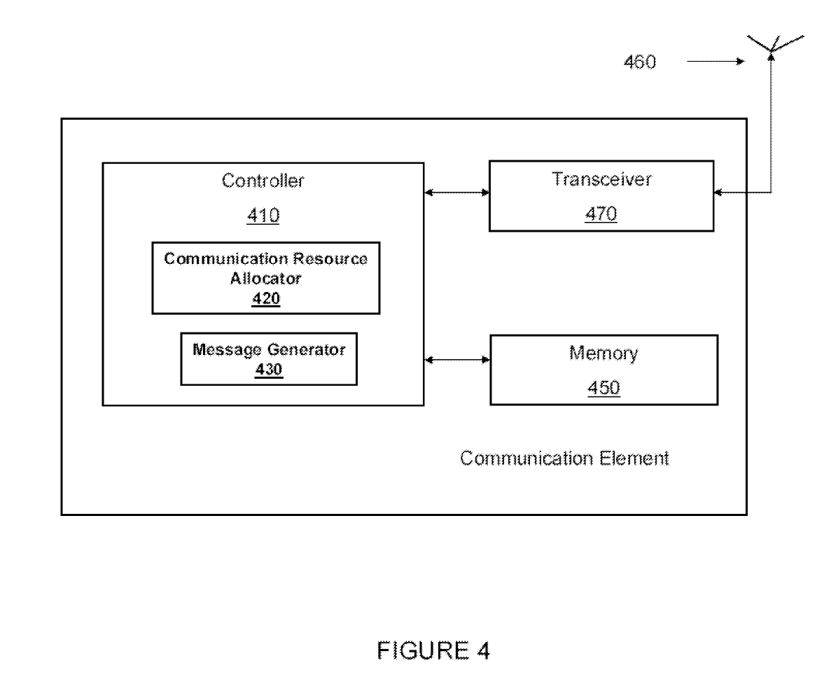

Due to the delay sensitive nature of VoIP traffic, the communication system performance may be significantly reduced due to the PDCCH coverage limitations at low PDSCH bandwidths. By extending the functionality of the VoIP packet scheduling systems and methods as introduced herein, better PDSCH coverage for user equipment at the edge of a cell may be enhanced, and the losses in VoIP capacity due to PDCCH coverage limitations may be accordingly reduced. While a communication resource allocation process for the PDCCH will hereinafter be described in the downlink direction, it should be understood that the principles as described herein are applicable in the uplink direction as well. Before introducing the exemplary method as mentioned above, an embodiment of a communication element will be described with respect to FIG. 4.

Referring now to FIG. 4, illustrated is a block diagram of an embodiment of a communication element of a wireless communication system that provides an environment for application of embodiments of the invention. The wireless communication system may include, for example, a cellular network. The communication element may represent, without limitation, a base station, a subscriber station such as a wireless communication device or user equipment, a network control element, or the like.

The communication element includes a controller or processor 410, memory 450 that stores programs and data of a temporary or more permanent nature, an antenna 460, and a radio frequency transceiver 470 coupled to the antenna 460 and to the controller 410 for bidirectional wireless communications. The communication element may provide point-to-point and/or point-to-multipoint communication services.

The communication element may be coupled to a communication network element, such as a network control element of a public switched telecommunication network. A network control element generally provides access to a core communication network such as a public switched telecommunication network (“PSTN”). Access to the communication network may be provided in fixed facilities, such as a base station, using fiber optic, coaxial, twisted pair, microwave communication, or similar link coupled to an appropriate link-terminating element (not shown). A communication element formed as a wireless communication device such as user equipment is generally a self-contained communication device intended to be carried by an end user.

The controller 410 in the communication element, which may be implemented with one or a plurality of processing devices, performs functions associated with its operation including, without limitation, encoding and decoding of individual bits forming a communication message, formatting of information, and overall control of the communication element, including processes related to management of communication resources. Exemplary functions related to management of communication resources include, without limitation, hardware installation, traffic management, performance data analysis, tracking of end users and equipment, configuration management, end user administration, management of subscriber stations, management of tariff, subscription, and security, and the like. The execution of all or portions of particular functions or processes related to management of communication resources may be performed in equipment separate from and/or coupled to the communication element, with the results of such functions or processes communicated for execution to the communication element. The controller 410 of the communication element may be of any type suitable to the local application environment, and may include one or more of general-purpose computers, special-purpose computers, microprocessors, digital signal processors (“DSPs”), field-programmable gate arrays (FPGAS), application-specific integrated circuits (ASICS), and processors based on a multi-core processor architecture, as non-limiting examples.

Typically in the environment of a base station, the memory 450 and computer program code is configured to, with the controller (or processor) 410, assess a capacity of a PDCCH, provide a pre-assigned communication resource for transmission of data to a communication device upon determining insufficient capacity is available in the PDCCH, and format the data for transmission to the communication device employing the pre-assigned communication resource. In a related embodiment, the controller (or processor) 410 includes a communication resource allocator 420 configured to assess a capacity (e.g., a bandwidth) of a PDCCH and provide a pre-assigned communication resource (via, for instance, radio resource control signaling) for transmission of data to a communication device (e.g., user equipment) upon determining insufficient capacity is available in the PDCCH. The pre-assigned communication resource may include a physical resource block and a modulation and coding scheme for transmission of the data, and be employed for an initial or retransmission of data. The communication resource allocator 420 is configured to provide a dynamically assigned communication resource for transmission of data to the communication device upon determining sufficient capacity is available in the PDCCH. The communication resources include information such as dynamic time and/or frequency allocation and the MCS to be used in the transmission of data. The communication resource allocator 420 of the controller 410 may determine that insufficient capacity is available in the PDCCH as a function of channel quality information (e.g., wideband channel quality information) from the communication device or consecutive unreceived HARQ acknowledgments or non-acknowledgements from the communication device. A message generator 430 of the controller 410 is configured to format the data (e.g., a VoIP data packet) for transmission to the communication device employing the pre-assigned or dynamically assigned communication resource.

Typically in the environment of a communication device (e.g., user equipment), the memory 450 and computer program code is configured to, with the controller (or processor) 410, receive a pre-assigned communication resource, and decode data with the pre-assigned communication resource when insufficient capacity is available in the PDCCH. In a related embodiment, the controller (or processor) 410 is configured to receive a pre-assigned communication resource, and decode data with the pre-assigned communication resource when insufficient capacity (e.g., bandwidth) is available in the PDCCH. The controller 410 is also configured to decode the data with a dynamically assigned communication resource when sufficient capacity is available in the PDCCH. The controller 410 is configured to provide channel quality information (e.g., wideband channel quality information) to indicate an availability of the PDCCH. The pre-assigned communication resource may include a physical resource block, a modulation and coding scheme or periodicity pattern to decode the data provided via radio resource control signaling. The data may also be formatted as a VoIP data packet.

The transceiver 470 of the communication element modulates information onto a carrier waveform for transmission of the information or data by the communication element via the antenna 460 to another communication element. The transceiver 470 demodulates information or data received via the antenna 460 for further processing by other communication elements.

The memory 450 of the communication element, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 450 may include program instructions or computer program code that, when executed by an associated processor, enable the communication element to perform tasks as described herein. Exemplary embodiments of the system, subsystems and modules as described herein may be implemented, at least in part, by computer software executable by processors of, for instance, the user equipment and the base station, or by hardware, or by combinations thereof. As will become more apparent, systems, subsystems and modules may be embodied in the communication element as illustrated and described above.

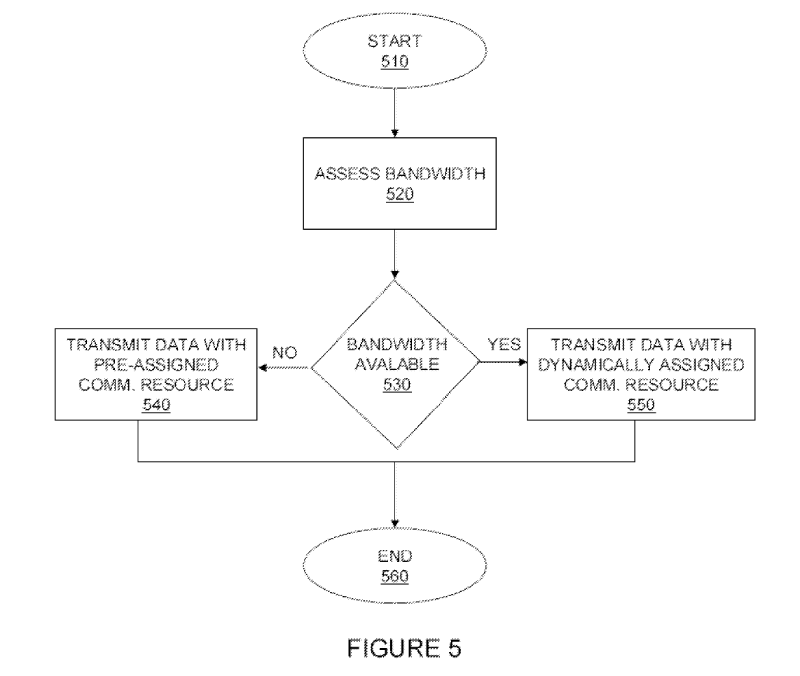

Turning now to FIG. 5, illustrated is a flow diagram of an embodiment of a method of operating a communication system in accordance with embodiments of the invention. Following a start step 510, the communication system assesses a bandwidth available in the PDCCH in a assess bandwidth step 520. The bandwidth information may be signaled to a communication device such as user equipment on a physical broadcast channel (“P-BCH”). If there is insufficient bandwidth available (or the user equipment is outside or beyond a coverage area of the PDCCH) as indicated by a bandwidth available decisional step 530, a pre-assigned communication resource (e.g., pre-assigned time and/or frequency transmission resources) is provided or assigned for the transmission of data (such as a VoIP data packet) by the user equipment at a step 540. The communication resources are allocated to reliably transmit the necessary time and/or frequency transmission resources to the user equipment for a VoIP data packet. The pre-assigned communication resources and other needed information such as the MCS are employed by the user equipment to decode the PDSCH correctly. As introduced herein, this information is transmitted using pre-assigned communication resources signaled to the user equipment via radio resource control (“RRC”) signaling. As a result, the associated PDCCH signaling is typically not needed to communicate this information, especially if the pre-assigned communication resource (by RRC signaling) is used in the transmission. The RRC signaling may be transmitted on a downlink shared channel, which may be mapped on the PDSCH.

In an exemplary embodiment, a base station starts to use pre-assigned communication resources for a VoIP data transmission for user equipment as a function of or based on, without limitation, wideband channel quality information from the user equipment or consecutive unreceived HARQ acknowledgments from the user equipment (i.e., unsent HARQ ACK/NACKs expected from the user equipment). Accordingly, the base station is able to determine that the user equipment is outside the PDCCH coverage area thereof. The VoIP traffic is transmitted by the base station using pre-assigned communication resources without associated PDCCH signaling, since these pre-assigned communication resources are transmitted in accordance with RRC signaling to the user equipment.

When it is determined that the user equipment is outside of the PDCCH coverage area, for example, based on the measured wideband CQI, the user equipment attempts to receive and decode a VoIP data packet transmission with the pre-assigned time/frequency resources that are signaled to the user equipment by using, for example, the RRC signaling. If there is sufficient bandwidth available (or the user equipment is within a coverage area of the PDCCH) as indicated by the bandwidth available decisional step 530, a dynamically assigned communication resource is provided (e.g., assigned) or employed for the transmission of a data (such as a VoIP data packet) by the user equipment at a step 550. Preferably, a signal indicating a dynamically assigned communication resource (e.g., dynamically allocated PDSCH transmission) would override an assumption characterizing a PDSCH transmission using pre-assigned or determined communication resources. In other words, the user equipment attempts to decode data using pre-assigned time and/or frequency communication resources when it has not received a PDCCH dynamic allocation in the same transmission time interval.

A base station stops using pre-assigned communication resources in the transmission of VoIP data packets to the user equipment when it determines that the user equipment is inside the PDCCH coverage area (i.e., that there is sufficient remaining PDCCH bandwidth to transmit the necessary communication resource information). For example, this determination can be made based on a wideband CQI signal received from the user equipment. It is important to use pre-assigned communication resources when needed so that other user equipment can benefit from such resources as well, since the same pre-assigned communication resources may be shared among multiple user equipment. Thus, the user equipment stops receiving and/or decoding transmissions using pre-assigned communication resources when it is inside the PDCCH coverage area and it receives PDCCH information dedicated thereto. The pre-assigned communication resources may include transmission resources for possible HARQ ACK/NACKs and/or re-transmissions of data. This means that synchronous HARQ should be used with a suitably selected periodicity pattern as signaled to the user equipment using the RRC resources.

In the beginning of a VoIP data transmission or other traffic connection set-up, a set of pre-assigned time and frequency resources and other information needed to receive and decode the PDSCH correctly, such as the MCS and the periodicity pattern, are sent to the user equipment via the RRC signaling. Alternatively, these communication resources (or a limited portion thereof) could be fixed or preset as determined by a specification.

Based on the wideband CQI received from the user equipment, including ACK/NACKs not received therefrom, the base station concludes that the user equipment is outside its PDCCH coverage area. Accordingly, the base station starts to transmit data for the user equipment using the pre-assigned communication resources, for example, in accordance with the RRC signaling mentioned above. If there are several pre-assigned communication resources that could be used, the base station selects an unused pre-assigned communication resource from this set. Since the user equipment initially decodes data transmissions using pre-assigned communication resources unless otherwise signaled in a PDCCH, the base station may change the pre-assigned communication resources used in transmission on a TTI-to-TTI basis to have more scheduling flexibility. It would also be possible to send a new persistent allocation to the user equipment (e.g., via RRC signaling) using the above-described communication resources reserved for PDCCH outage situations. These other communication resources could then be freely selected, thus reducing the amount of communication resource and MCS combinations that need to be reserved and monitored.

The user equipment starts listening and decoding transmissions using pre-assigned communication resources when it is able to determine, for example, based on a wideband CQI signal that it transmits, that it is out of the PDCCH coverage area. Based on wideband CQI received from the user equipment, a base station is able to determine when the user equipment returns to the PDCCH coverage area. When the user equipment returns to the PDCCH coverage area, the base station stops transmitting data with pre-assigned communication resources for the user equipment and signals the same to the user equipment by making the next transmission with associated PDCCH signaling employing dynamic communication resources. If talk spurt-based persistent packet scheduling is used, the base station may inform the user equipment about a new persistent allocation, for example, by transmitting on the PDCCH a semi-persistent cell radio network temporary identifier (“C-RNTI”) to indicate that this communication resource allocation is persistent. When the user equipment successfully receives and decodes a PDCCH allocation targeted to the user equipment, the user equipment can stop receiving and decoding transmissions with the pre-assigned communication resources. An advantage of communication of control data to the user equipment with the pre-assigned communication resources as introduced herein is that the negative impact of limited PDCCH coverage is reduced, particularly at low PDCCH bandwidths, or for user equipment operating in a poor communication environment. The method of operating the communication system is concluded at an end step 560. It should be understood that selected steps of the method of operating the communication system may be reordered or omitted, or other steps may be added thereto, and still fall within the broad scope of the present invention.

In addition, program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk-ROM (“CD-ROM”), an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1.-30. (canceled)

31. An apparatus, comprising:
a processor; and
memory including computer program code said memory and said computer program code configured to, with said processor, cause
said apparatus to perform at least the following:
assess a capacity of a physical downlink control channel,
provide a pre-assigned communication resource for transmission of data to a communication device upon determining insufficient capacity is available in said physical downlink control channel, and
format said data for transmission to said communication device employing said pre-assigned communication resource.

32. The apparatus according to claim 31 wherein said memory including said computer program code is configured to, with said processor, cause said apparatus to provide a dynamically assigned communication resource for transmission of data to said communication device upon determining sufficient capacity is available in said physical downlink control channel.

33. The apparatus according to claim 31 wherein said memory including said computer program code is configured to, with said processor, cause said apparatus to determine that insufficient capacity is available in said physical downlink control channel as a function of at least one of channel quality information from said communication device and consecutive unreceived hybrid automatic retransmit request acknowledgments from said communication device.

34. The apparatus according to claim 31 wherein said pre-assigned communication resource is provided via radio resource control signaling.

35. The apparatus according to claim 31 wherein said pre-assigned communication resource comprises a modulation and coding scheme and periodicity pattern for transmission of said data via radio resource control signaling.

36. The apparatus according to claim 31 wherein said data is formatted as a voice over internet protocol data packet.

37. The apparatus according to claim 31 wherein the apparatus is a base station or a network control element.

38. An apparatus, comprising:
a processor; and
memory including computer program code
said memory and said computer program code configured to, with said processor, cause said apparatus to perform at least the following:
receive a pre-assigned communication resource, and
decode data with said pre-assigned communication resource when insufficient capacity is available in a physical downlink control channel.

39. The apparatus according to claim 38 wherein said memory including said computer program code is configured to, with said processor, cause said apparatus to decode said data with a dynamically assigned communication resource when sufficient capacity is available in said physical downlink control channel.

40. The apparatus according to claim 38 wherein said memory including said computer program code is configured to, with said processor, cause said apparatus to provide channel quality information to indicate an availability of said physical downlink control channel.

41. The apparatus according to claim 38 wherein said pre-assigned communication resource is provided via radio resource control signaling.

42. The apparatus according to claim 38 wherein said pre-assigned communication resource comprises a modulation and coding scheme and periodicity pattern to decode said data provided via radio resource control signaling.

43. The apparatus according to claim 38 wherein said data is formatted as a voice over internet protocol data packet.

44. The apparatus according to claim 38 wherein the apparatus is user equipment.

45. A method, comprising:
receiving a pre-assigned communication resource; and
decoding data with said pre-assigned communication resource when insufficient capacity is available in said physical downlink control channel.

46. The method according to claim 45 further comprising decoding said data with a dynamically assigned communication resource when sufficient capacity is available in said physical downlink control channel.

47. The method according to claim 45 further comprising providing channel quality information to indicate an availability of said physical downlink control channel.

48. The method according to claim 45 wherein said pre-assigned communication resource comprises a modulation and coding scheme and periodicity pattern to decode said data provided via radio resource control signaling.

49. The method according to claim 45 wherein said data is formatted as a voice over internet protocol data packet.
